(19) United States
(12) Patent Application Publication
(10) Pub. No.: US 2014/0337847 A1
(43) Pub. Date: Nov. 13, 2014

(54) CLUSTER SYSTEM AND METHOD FOR EXECUTING A PLURALITY OF VIRTUAL MACHINES

(71) Applicant: Fujitsu Technology Solutions Intellectual Property GmbH, Muenchen (DE)

(72) Inventor: Henning Klein, Egling a. d. Paar (DE)

(73) Assignee: Fujitsu Technology Solutions Intellectual Property GmbH, Muenchen (DE)

(21) Appl. No.: 14/353,889

(22) PCT Filed: Oct. 19, 2012
(86) PCT No.: PCT/EP2012/070770

§ 371 Date: Apr. 24, 2014

(30) Foreign Application Priority Data
Oct. 25, 2011 (DE) 102011116866.8

(51) Int. Cl. G06F 9/455; H04L 29/08

(52) U.S. Cl. CPC G06F 9/45533; H04L 67/1095
USPC 718/1

(57) ABSTRACT

A cluster system includes a plurality of server computers and a data network. The cluster system is arranged to execute a plurality of virtual machines, wherein each of the virtual machines is allocated at least one virtual mass storage device. For each virtual machine, a first copy of the data of the associated virtual mass storage device is thereby stored on at least one local mass storage device of a first server computer and a second copy of the data of the associated virtual mass storage device is stored on at least one local mass storage device of a second server computer.

### TECHNICAL FIELD

This disclosure relates to a cluster system comprising a plurality of server computers and a data network that executes a plurality of virtual machines. Moreover, the disclosure relates to a method of executing a plurality of virtual machines on a plurality of server computers.

### BACKGROUND

In the area of electronic data processing, parallel execution of a plurality of possibly different operating systems on at least partially common resources of a computer, in particular processors, main and mass storage devices thereof under the control of virtualization software such as in particular a hypervisor is understood as virtualization. Different types of virtualization are known.

In the so-called “virtual desktop infrastructure”—VDI, an existing client installation of a user is transferred to a virtual machine or a new virtual machine is set up for a user. The virtual machine with the client installation, for example, an operating system with associated user-specific software, is executed by a server computer in a data network. The user utilizes a particularly simple client computer, in particular a so-called “thin” or “zero client” to access the virtual machine via the data network. Alternatively, a conventional fat client with terminal software installed thereon can also be used to access the virtual machine. All programs started by the user are executed within the virtual machine by the server computer and not on the client computer. The virtual machine thus accesses resources of the server computer such as processor or memory resources to execute the user programs.

Other types of virtualization, in particular, so-called “server virtualization,” are also fundamentally known. In the case of server virtualization, a service provided by a server computer is encapsulated in a virtual machine. In this way it is possible, for example, to execute a web server and a mail server, which each require different executing environments, on a common physical server computer.

To achieve a uniform workload on the available server computers, an assignment of virtual machines to server computers is generally controlled by a so-called “connection broker” or a similar management tool. The connection broker ensures inter alia that virtual machines to be newly started are started on a server computer which still has sufficient resources to execute them. Known virtualization systems thereby presuppose a separate memory server which can be accessed by all server computers of a cluster system to permit execution of a virtual machine on any server computer.

One possible architecture of a virtualization system is shown by way of example in FIG. 1. In the example illustrated in FIG. 1, three virtual machines 11a, 11b and 11c are executed on a common server computer 12. In addition to the server computer 12 shown in FIG. 1, further server computers are provided which are also suitable to execute the virtual machines 11a to 11c.

Each of the virtual machines 11a to 11c is allocated a dedicated virtual mass storage device 13a to 13c. A hypervisor or another virtualization software of the server computer 12 emulates—for the virtual machines 11—the presence of a corresponding physical mass storage device. For an operating system executed on the virtual machine 11a the virtual mass storage device 13a therefore appears, for example, as a locale SCSI hard disk. Upon access to the virtual mass storage device 13a, the virtualization software invokes a so-called “iSCSI initiator” 14. The iSCSI initiator 14 recognizes that access to the virtual mass storage device 13a is desired and passes a corresponding SCSI enquiry via a data network 15 to a separate memory server 16. Control software runs on the memory server 16, this control software providing a so-called “iSCSI target” 17 for enquiries of the iSCSI initiators 16. The iSCSI target 17 passes the received enquiries to a hard disk drive 18 of the memory server 16. In this way, inquiries from all the machines 11a to 11c of the server computer 12 are answered centrally by the memory server 16.

One problem with the architecture shown in FIG. 1 is that all memory accesses of all virtual machines 11a to 11c always take place via the data network 15 and are answered by one or a few hard disk drives 18 of the memory server 16. The virtual machines 11a to 11c therefore compete for bandwidth in the data network 15. In addition, competing inquiries can only be answered by the memory server 16 one after the other.

If the cluster system 10 shown in FIG. 1 is expanded by addition of further server computers 12 to execute further virtual machines 11, then not only the demand for memory capacity on the hard disk drive 18 of the memory server 16 will increase, but also the latency time associated with access to the virtual mass storage devices 13.

It could therefore be helpful to provide a cluster system and a working method for a cluster system in which the latency time for access to virtual mass storage devices of a virtual machine is reduced and suitable for flexible expansion of cluster systems without accompanying losses in performance of known systems.

### SUMMARY

I provide a method of executing a plurality of virtual machines on a plurality of server computers including starting a first virtual machine on a first server computer with a first local mass storage device; starting a second virtual machine on a second server computer with a second local mass storage device; receiving a first write request from the first virtual machine; carrying out the first write request to change first data on the first local mass storage device; receiving a second write request from the second virtual machine; carrying out the second write request to change second data on the second local mass storage device; synchronizing changed first data between the first server computer and the second server computer via a data network; and synchronizing changed second data between the second server computer and the first server computer via the data network, wherein, in synchronizing, the changed first or second data, changed data of more than one write request of the first virtual machines or the second virtual machines are combined for a specific period of time or for a specific volume of data and combined changes are transferred together to the second server computer or the server first computer, respectively.

I also provide a cluster system including a plurality of server computers each with at least one processor, at least one local mass storage device and at least one network component, and a data network, via which the network components of the plurality of server computers are coupled to exchange data, wherein the cluster system is arranged to execute a plurality of virtual machines; each of the virtual machines is allocated at least one virtual mass storage device; for each virtual machine, a first copy of the data of the allocated virtual mass storage device is stored on the at least one local mass storage device of a first server computer and a second copy of the data of the allocated virtual mass storage device is stored on the at least one local mass storage device of a second server computer of the plurality of server computers; during execution of an active virtual machine of the plurality of virtual machines by the at least one processor of the first server computer mass storage device accesses of the active virtual machine to the at least one virtual mass storage device allocated thereto are redirected to the local mass storage device of the first server computer; during execution of the active virtual machines by the at least one processor of the second server computer mass storage device accesses of the active virtual machine to the at least one virtual mass storage device allocated thereto are redirected to the local mass storage device of the second server computer; and changes in the first copy and in the second copy of the data of the virtual mass storage device of the active virtual machine are synchronized via the data network with the second copy and the first copy, respectively.

I further provide a method of executing a plurality of virtual machines on a plurality of server computers including starting a first virtual machine on a first server computer with a first local mass storage device; starting a second virtual machine on a second server computer with a second local mass storage device; receiving a first write request from the first virtual machine; carrying out the first write request to change first data on the first local mass storage device; receiving a second write request from the second virtual machine; carrying out the second write request to change second data on the second local mass storage device; synchronizing changed first data between the first server computer and the second server computer via a data network; and synchronizing changed second data between the second server computer and the first server computer via the data network.

### BRIEF DESCRIPTION OF THE DRAWINGS

FIG. 1 shows known architecture of a cluster system with a separate memory server.

FIG. 2 shows an example of my architecture of a cluster system.

FIG. 3 shows a cluster system with three server computers according to an example.

FIG. 4 shows a flow diagram of a method of parallel execution of two virtual machines.

FIG. 5 shows a flow diagram of a method of shifting a virtual machine.

FIGS. 6A and 6B show a flow diagram of a method of synchronizing virtual mass storage devices.

### REFERENCE LIST

10 cluster system
11 virtual machine
12 server computer
13 virtual mass storage device
14 iSCSI initiator
15 data network
16 memory server
17 iSCSI target
18 hard disk drive
20 cluster system
21 filter driver
22 local mass storage device
23 virtualization layer
24 first copy of the virtual mass storage device
24 second copy of the virtual mass storage device
30 cluster system
31 virtual desktop
32 synchronization module
33 memory server software
34 administration service

### DETAILED DESCRIPTION

I provide a cluster system having a plurality of server computers each with at least one processor, at least one local mass storage device and at least one network component, and has a data network, via which the network components of the plurality of server computers are coupled to exchange data. The cluster system is arranged to execute a plurality of virtual machines, wherein each of the virtual machines is allocated at least one virtual mass storage device. For each virtual machine, a first copy of the data of the allocated virtual mass storage device is thereby stored on the at least one local mass storage device of a first server computer and a second copy of the data of the allocated virtual mass storage device is stored on the at least one local mass storage device of a second server computer of the plurality of server computers. During execution of an active virtual machine of the plurality of virtual machines by the at least one processor of the first server computer, data accesses of the active virtual machine to the at least one virtual mass storage device allocated thereto are redirected to the local mass storage device of the first server computer. During execution of the active virtual machine by the at least one processor of the second server computer, mass storage device accesses of the active virtual machine to the at least one virtual mass storage device allocated thereto are redirected to the local mass storage device of the second server computer. Changes in the first or second copy of the data of the virtual mass storage device of the active virtual machine are thereby synchronized over the data network with the second and first copy respectively.

In the cluster system, copies of the virtual mass storage devices are stored on at least two server computers. The local mass storage devices of the server computers are thereby used as virtual mass storage devices for the virtual machines. By local mass storage device accesses, unnecessary transfers over a data network are avoided, which reduces latency times of data accesses and splits the number of accesses to the local mass storage devices of the plurality of server computers. To avoid inconsistencies in data and permit shifting of virtual machines from one server computer to the other, the locally effected changes are synchronized from one server computer to the other server computer.

I exploited the knowledge that in server computers, local mass storage devices, in particular hard disks, are generally provided to start a host-operating system or a hypervisor. The performance thereof, however, is generally underused since the operating system or hypervisor of the server computer takes up a relatively small memory volume and requires only a few accesses to the local mass storage device.

As a result, with my cluster systems, a reduction in the latency time during access to virtual mass storage devices of a virtual machine is effected, wherein at the same time improved scalability of the cluster system as a whole is produced. In particular, both the performance and capacity of the available mass storage devices are increased by addition of further server computers, without separate and particularly high-performance memory servers being required for this purpose.

For effective implementation of the synchronization, preferably, each of the plurality of server computers has a synchronization module. The synchronization module of the first server computer is thereby arranged for a specific period of time or for a specific volume of data, to combine the changes in the first copy of the data of the virtual mass storage device of the active virtual machine and send them together to the second server computer. This combination of changes means that the network traffic can be reduced further via a data network used for coupling purposes.

With at least one of the server computers, in particular with a virtual machine executed on the at least one server computer, memory server software may be executed. The memory server software may thereby be arranged to provide the content of the virtual mass storage devices of the plurality of virtual machines via the data network. Execution of memory server software by a server computer of the cluster system simplifies synchronization of the virtual mass storage devices, improves compatibility with existing virtualization systems and at the same time ensures that a virtual machine can be successfully started on any server computer of the cluster system. By virtualization of a memory server, it is possible to dispense with the additional provision of a separately configured or equipped data server or server computer.

Each of the plurality of server computers may have a filter driver, wherein the filter driver is arranged to intercept mass storage device accesses by a virtual machine locally executed by the at least one processor of the server computer and to redirect them to the first copy of the data of the at least one virtual mass storage device on the local mass storage device.

I also provide a method of executing a plurality of virtual machines on a plurality of server computers. The method comprises the following steps:
starting a first virtual machine on a first server computer with a first local mass storage device,
starting a second virtual machine on a second server computer with a second local mass storage device,
receiving a first write request from the first virtual machine,
carrying out the first write request to change first data on the first local mass storage device,
receiving a second write request from the second virtual machine,
carrying out the second write request to change second data on the second local mass storage device,
synchronizing the changed first data between the first server computer and the second server computer via a data network, and
synchronizing the changed second data between the second server computer and the first server computer via the data network.

By the method steps, local storage of data of virtual machines is effected at the same time as redundancy is produced on a respective other local mass storage device of a second server computer.

The method of synchronization of the first data or of the second data may be a combined packet by packet and/or carried out in a transaction-oriented manner.

The method may additionally comprise the steps of:
pausing the first virtual machine on the first server computer,
waiting until the step of synchronizing the first changed data has been completed, and
subsequently starting the first virtual machine on the second server computer.

With those steps, a virtual machine can be transferred from one server computer to another server computer of the cluster system without inconsistencies occurring in the data of the virtual mass storage device.

In the following detailed description, the reference signs are used consistently for like or similar components of different examples. Furthermore, different instances of similar components are differentiated by appending a suffix letter. Unless the description relates to a particular instance of a component the respective reference sign is used without the appended suffix.

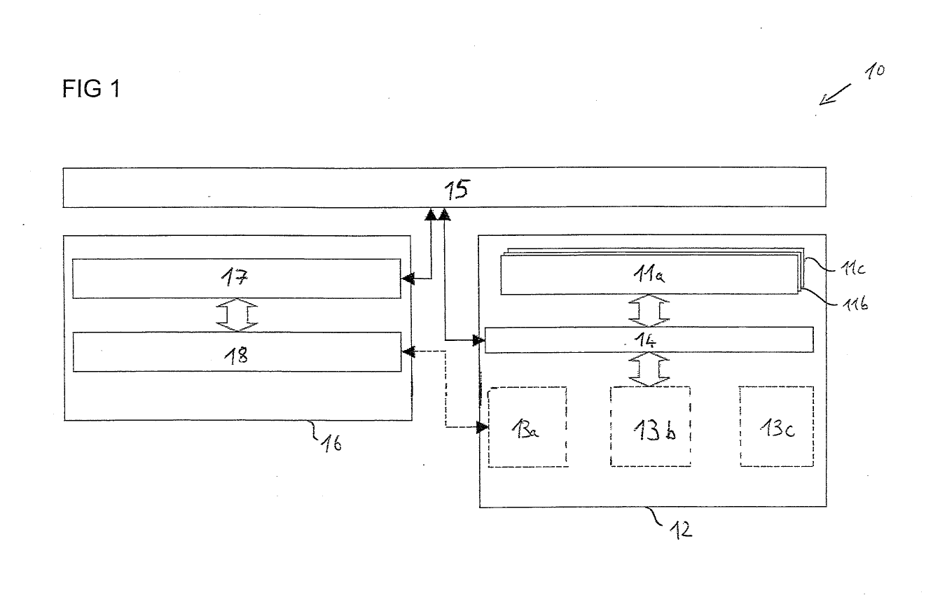

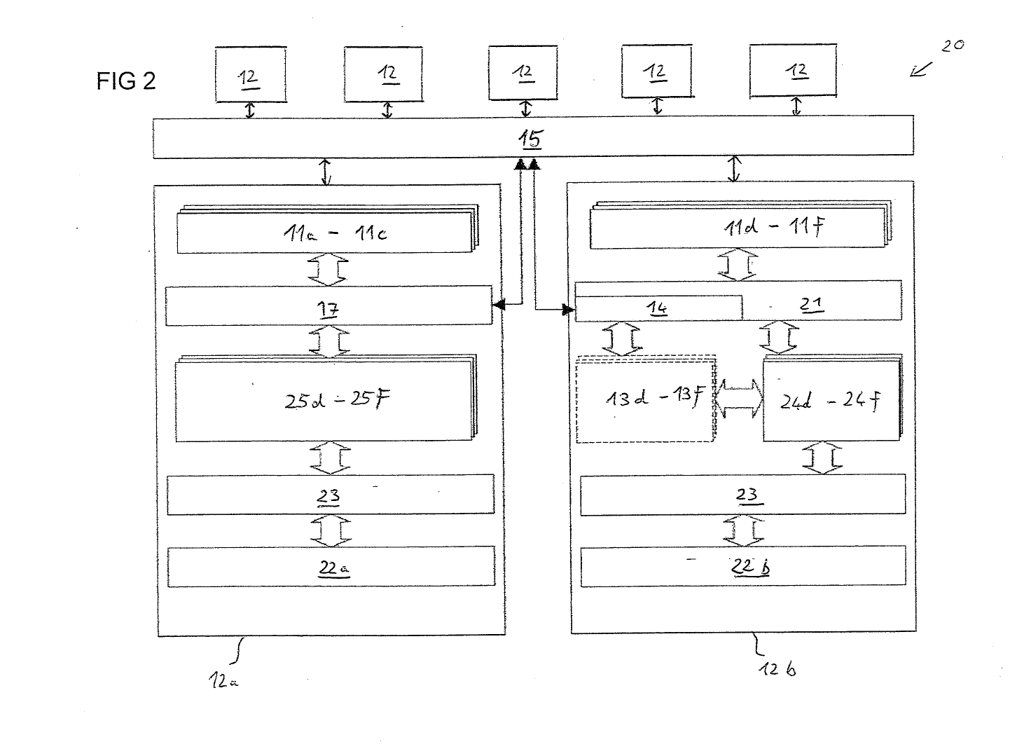

FIG. 2 shows a cluster system 20 with a first server computer 12a, a second server computer 12b and further server computers 12 not shown in detail. The server computers 12 connect to one another via a common data network 15. The structure of the cluster system 20 is similar to the structure of the cluster system 10 of FIG. 1. As a departure therefrom no separate memory server is used in the architecture of FIG. 2. Instead, for reasons of compatibility on the server computer 12a in the illustrated example, memory server software runs in a virtual machine 11a on the first server computer 12a. In addition to the virtual machine 11a, further virtual machines 11b to 11c can also be provided by the first server computer 12a.

Further virtual machines 11d to 11f are executed by the server computer 12b in the example. If one of the virtual machines 11d to 11f accesses a virtual mass storage device 13d to 13f allocated thereto, a filter driver 21 intercepts the corresponding mass storage device access. The filter driver 21 does not forward the memory enquiry, as described with reference to FIG. 1, to the iSCSI initiator 14, but rather redirects the inquiry to a local mass storage device 22b, in particular an incorporated hard disk drive, of the server computer 12b. A first copy 24d to 24f of the respective virtual mass storage devices 13d to 13f is thereby stored on the local mass storage device 22b. In the example the copies 24d to 24f are copies of a so-called “hard disk container” used by a virtualization layer 23.

As long as the virtual machines 11d to 11f are not shifted from the server computer 12b to one of the other server computers 12, all accesses take place via the filter driver 21 to the local first copies 24d to 24f of the local mass storage device 22b of the server computer 12b. It is therefore largely possible to dispense with accesses to the data network 15, which reduces, in particular, the latency times in mass storage device access of the virtual machines 11d to 11f.

To ensure a fail-safe capability with respect to failure of the server computer 12b or the components installed therein, such as, in particular, the local mass storage device 22b, the contents of the virtual mass storage devices 13d to 13f, which are stored in the copies 24d to 24f on the local mass storage device 22b, are reproduced as second copies 25d to 25f on at least one remote mass storage device, in the example of the local mass storage device 22a of the first server computer 12a. This simultaneously permits shifting of individual ones or of all the virtual machines 11d to 11f onto the server computer 12a.

In the example, the copies 24 and 25 are synchronized by a background task which is regularly carried out on each of the server computers 12. To simplify synchronization and obtain compatibility with existing cluster software, the data transfer thereby takes place as described with reference to FIG. 1 by an iSCSI initiator 14 in the case of the second server computer 12b and an iSCSI target 17 in the case of the first server computer 12a which executes the memory server software. As explained with reference to FIG. 1, the memory server software executed on the first server computer 12a makes the virtual mass storage devices 13d to 13f available via the data network 15. These are incorporated as network drives by the other server computers 12, in particular the second server computer 12b. The background task carried out on the second server computer 12b then merges the first copies 24d to 24f with the second copies 25d to 25f of the virtual mass storage devices 13d to 13f provided via the data network 15.

Preferably, all changes in a first copy 24 are combined and collected in an update message for a specific period, for example, 15 seconds or a minute, or in a specific range, for example, changed blocks or sectors with an overall size of one megabyte, or are transferred block by block via the iSCSI initiator 14 to the iSCSI target 17 of the first server computer 12a. Alternatively, synchronization can also take place when the first or second computer system 12a or 12b, the data network 15 and/or the mass storage devices 22a or 22b are found to have particularly low occupancy. The iSCSI target 17 of the first server computer 12a then updates the second copies 25 of the virtual mass storage devices 13 on the local mass storage device 22a.

Although this is not shown in FIG. 2 for reasons of clarity, the virtual machines 11a to 11c are also allocated virtual mass storage devices 13a to 13c, the contents of which are stored as first copies 24 on the local mass storage device 22a of the first server computer 12a and as second copies 25 on at least one local mass storage device 22 of another server computer 12 and are synchronized in an equivalent manner.

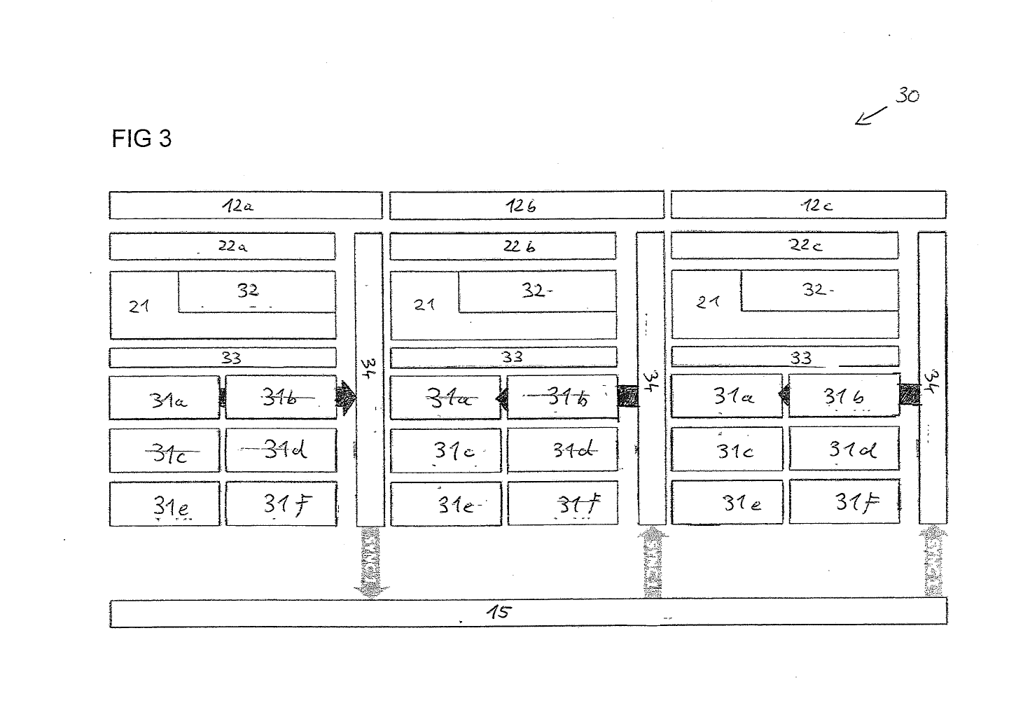

FIG. 3 shows a further example of a cluster system 30 used for a virtual desktop infrastructure. In the illustrated example, the cluster system 30 includes three server computers 12a to 12c, via which a total of six virtual desktops 31a to 31f are provided. Each of the virtual desktops 31 is implemented via a virtual machine 11 allocated there to and which is allocated at least one virtual mass storage device 13. For reasons of clarity, the virtual machines 11 and virtual mass storage devices 13 are not shown in FIG. 3.

Each server computer 12 has one or more local mass storage devices 22 such as, in particular, an internal hard drive, a filter driver 21 and a synchronization module 32. In addition, on each of the server computers 12, memory server software 33 that provides the functionality of a conventional memory server 16 is installed. However, at any one time, the memory server software 33 is executed by only one of the three server computers 12a to 12c, for example, the first server computer 12a. In the event of failure of the first server computer 12a, an administration service 34 activates the memory server software 33 on one of the other server computers 12b or 12c so that this server computer 12b or 12c can at any time take over the function of the server computer 12a.

The administration service 34 also distributes the virtual desktops 31 to the server computers 12. In the illustrated example, the virtual desktops 31a to 31f are uniformly distributed over the three server computers 12a to 12c. In particular, the virtual desktops 31a and 31b are hosted by the first server computer 12a, the virtual desktops 31c and 31d are hosted by the second server computer 12b and the virtual desktops 31e and 31f are hosted by the third server computer 12c.

In the cluster system 30 of FIG. 3, the storage capacity of the local mass storage devices 22a to 22c is sufficient to hold the virtual mass storage devices 13 of each of the virtual desktops 31a to 31f. To permit execution of each of the virtual desktops 31a to 31e on each of the server computers 12a to 12c, the virtual mass storage devices 13 of the virtual desktops 31a to 31f are stored as a copy on each of the mass storage devices 22a to 22c. With the administration service 34 and the synchronization module 32, a respective synchronization of the contents of the virtual mass storage devices 13 takes place.

In the illustrated example, changes in the content of the virtual mass storage devices 13 caused by the virtual desktops 31a and 31b active on the first server computer 12a, are distributed to the server computers 12b and 12c via a broadcast communication of the data network 15. The server computers 12b and 12c then update their corresponding copies of the associated virtual mass storage devices 13 accordingly. In FIG. 3 this is indicated as an example for the first virtual desktop 31a by the arrows. Conversely, changes in the virtual mass storage devices 13 of the virtual desktops 31c and 31d are transferred by broadcast from the second server computer 12b to the server computers 12a and 12c. The changes in the virtual mass storage devices 13 of the virtual desktops 31e and 31f are accordingly transferred from the third server computer 12c to the server computers 12a and 12b.

To distribute the bandwidth of the individual local mass storage devices 12 fairly between accesses caused by the synchronization and caused by a local user of the mass storage devices 12, the requests used for the synchronization are not synchronized immediately in one example but transferred block by block upon request of the synchronization module 32 or of the administration service 34.

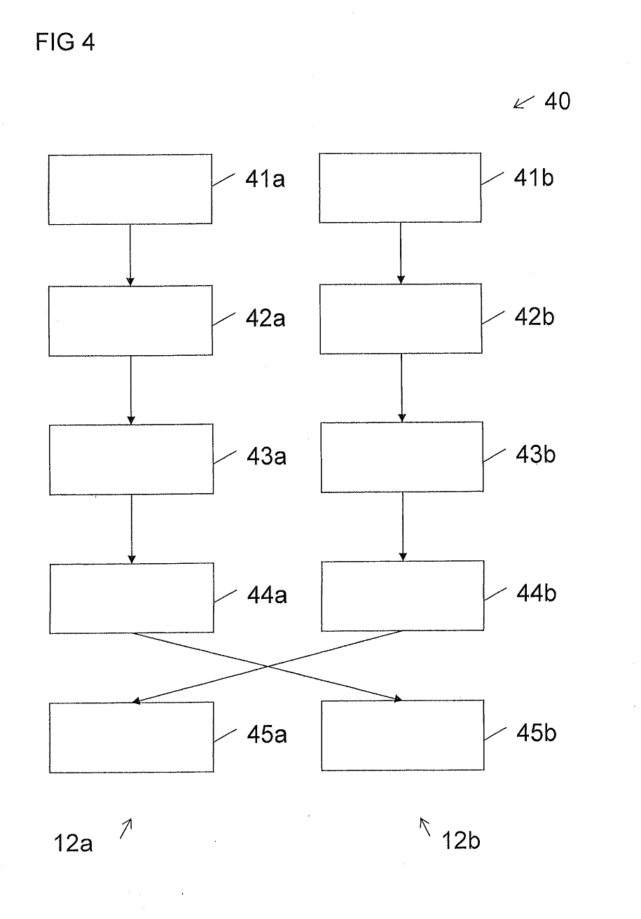

A specific synchronization process and shifting of virtual machines 11 and, therefore, of the virtual desktops 31 provided thereby from one server computer 12 to another server computer 12 is described below with the aid of the flow diagrams of FIGS. 4 to 6.

FIG. 4 shows a flow diagram of a method 40 of operation of a cluster system, for example, one of the cluster systems 20 or 30. The left half of FIG. 4 shows the steps carried out by a first server computer 12a of the cluster system. The right half of FIG. 4 shows the steps carried out by a second server computer 12b.

By reason of parallel execution of the method steps on two different server computers 12, these do not take place in a time-synchronized manner with respect to each other. Only in the event of the synchronization of changes in the contents of a virtual mass storage device 13 does a synchronization, to be described in more detail below, take place between the first server computer 12a and the second server computer 12b.

In a first step 41a, a first virtual machine 11a is started. For example, a Windows operating system is started for a user who accesses a virtual machine 11a via the virtual desktop infrastructure. In a step 42a management software of the server computer 12a, for example, a hypervisor executed on the server computer 12a, receives a write inquiry of the first virtual machine 11a. For example, a user may wish to store a changed text document on a virtual mass storage device 13a of virtual machine 11a. This request is first locally converted in step 43a. For this purpose the write command is intercepted by a filter driver 21 of the server computer 12a and converted into a local write command for the local mass storage device 22a.

In parallel thereto, in the method steps 41b to 43b, corresponding operations for a second virtual machine 11b are carried out on a second server computer 12b. Changes in the second virtual machine 11b on the virtual mass storage device 13b are first once again carried out on a local mass storage device 22b of the second server computer 12b.

In a step 44a, for example, after expiration of a predetermined time or after accruing a predetermined number of changes, the first server computer 12a combines the changes carried out thus far by the virtual machine 11a and transfers a corresponding first update message to the second server computer 12b. The second server computer 12b receives the first update message in a step 45b and updates its copy of the virtual mass storage device 13a of the first virtual machine 11a accordingly. Conversely, in a step 44b the second server computer 12b transfers the changes thus far accrued of the second virtual machine 11b to the copy 24 thereof of the virtual mass storage device 13b on the local mass storage device 22b and transfers this in the form of a second update message to the first server computer 12a. In a step 45a, the first server computer 12a updates its copy of the virtual mass storage device 13b of the second virtual machine 11b accordingly.

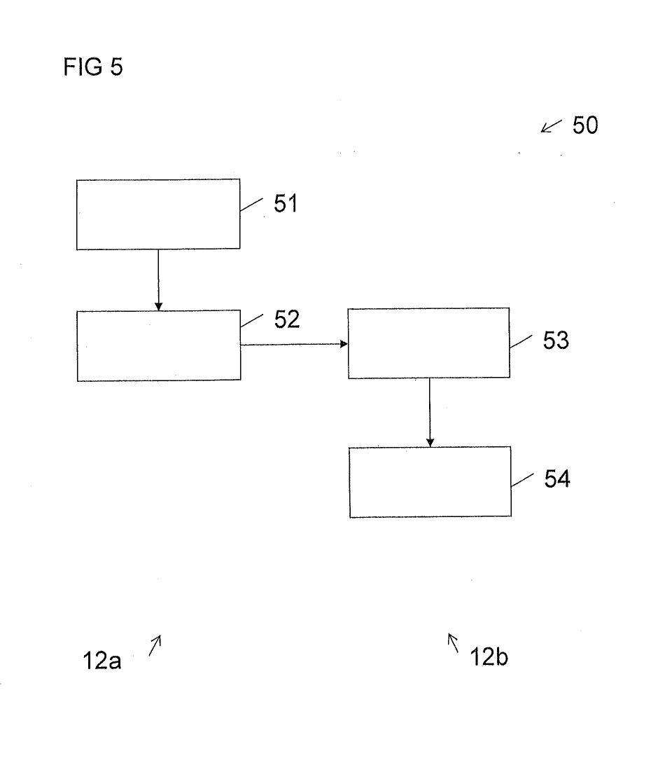

FIG. 5 schematically illustrates a method 50 of shifting a virtual machine 11 from a first server computer 12a to a second server computer 12b. As in FIG. 4, the steps of the first server computer 12a are shown on the left side of FIG. 5 and the method steps of the second server computer 12b are shown on the right side of FIG. 5.

In a first step 51, execution of the virtual machine 11 on the first computer 12a is paused. For example, no further processor time is assigned by an administration service 34 or a hypervisor of the virtual machine 11.

In a step 52, the changes which have taken place thus far on a virtual mass storage device 13, which is allocated to the virtual machine 11, are then combined in an update message. The update message is transferred from the first server computer 12a to the second server computer 12b. In a step 53, this updates its local copy 25 of the virtual mass storage device 13 of the virtual machine 11 corresponding to the changes in the update message.

Execution of the virtual machine 11 on the second server computer 12b can then be continued in a step 54. In one example, the current state of the working memory of the virtual machine 11 is then contained in the update message and/or on the virtual mass storage device 13 so that it is synchronized between the server computers 12a and 12b in steps 52 and 53. Alternatively, the current state of the working memory is transferred by the provided cluster software, for example, the administration service 34. In both cases, the virtual machine 11 starts in step 54 in precisely the same state as that in which it was stopped in step 51, thus, for example, with the execution of the same applications and the same opened documents. For a user of the virtual machine 11 there is therefore no perceptible difference between execution of the virtual machine 11 on the first server computer 12a or on the second server computer 12b.

In a further example, not shown, synchronization of the virtual mass storage device 13 between a local mass storage device 22a of the first server computer 12a and a local mass storage device 22b of the second server computer 12b is carried out in parallel with execution of the virtual machine 11. For example, parts or the entire content of the virtual mass storage device 13 can be transferred to the second server computer 12b prior to pausing the virtual machine 11. It is also possible to start the virtual machine 11 on the second server computer 12b close in time to pausing the virtual machine 11 on the first server computer 12a, and to carry out synchronization of the associated virtual mass storage device 13 only subsequently, i.e., during execution of the virtual machine 11 by the second server computer 12b.

If necessary, content which has not yet been transferred to the local mass storage device 22b of the second server computer 12b can therefore be read for a transition time via the data network 15 from the local mass storage device 22a of the first server computer 12a.

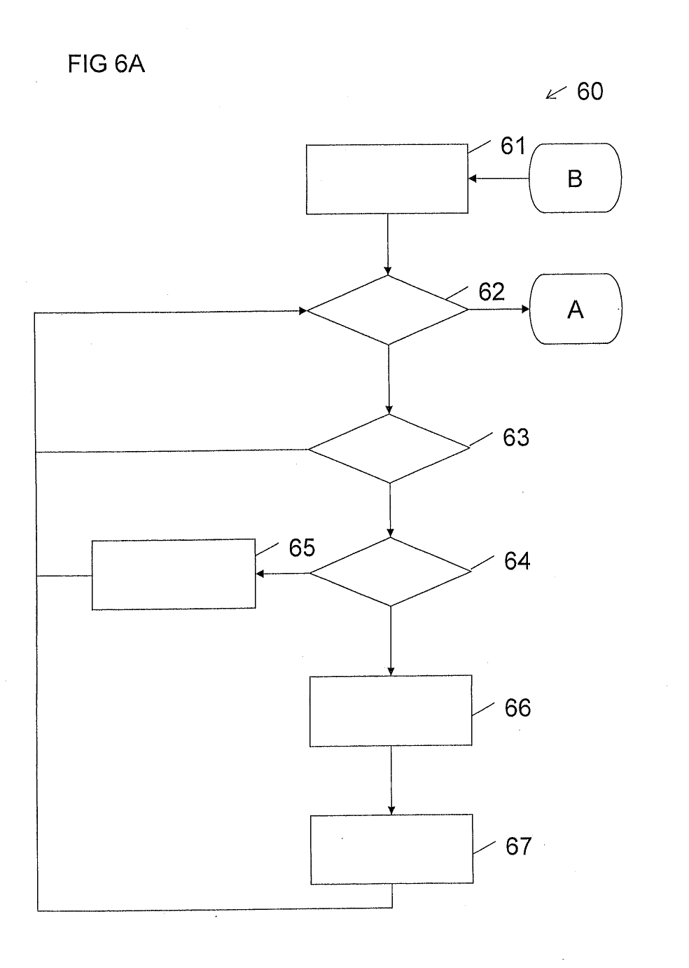

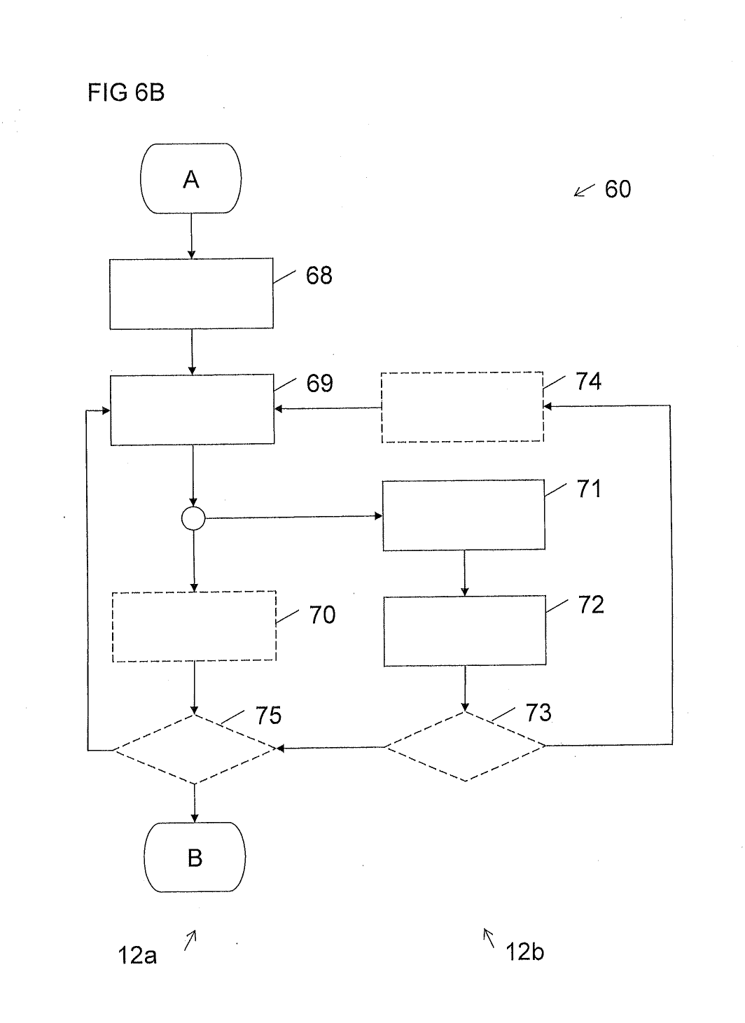

FIGS. 6A and 6B schematically show the progress of a possible synchronization method 60 of merging copies 24 and 25 of a virtual mass storage device 13 between two different server computers 12a and 12b.

In a first step 61, a timer or other counter of the first server computer 12a is reset. In a subsequent step 62 a check is made as to whether a predetermined time interval T, for example, a time interval of one minute, has already passed or a counter event, for example, a change in 1000 blocks or sectors of a virtual mass storage device 13 has already occurred. If this is not the case, then in a step 63 a check is made whether a read or write request of a locally executed virtual machine 11 has been detected by the second server computer 12a. If this is not the case, the method continues in step 62.

Otherwise, in step 64 the type of the detected request of the virtual machine 11 is checked. If it is a read request, then in step 65, the corresponding read request is passed to the local mass storage device 22a of the server computer 12a and answered thereby with the aid of a local first copy 24 of the virtual mass storage device 13. Since a read request does not cause inconsistency between different copies 24 and 25 of the virtual mass storage device 13 the method can be continued without carrying out further measures in step 62.

However, if in step 64 it is recognized that a write command is present, then in a step 66 a block or sector to be written of the local copy of the virtual mass storage device 13 is marked as changed in a suitable data structure. For example, the filter driver 21 stores an address of each locally overwritten block in an occupancy list in the working memory in a table of the synchronization module 32 or in suitable metadata of the associated file system. The write request is then carried out in step 67 on the local mass storage device 22a of the server computer 12a and the method is again continued in step 62.

If the predetermined synchronization result finally occurs in step 62, the first copy 24 of the virtual mass storage device 13 on the local mass storage device 22a is synchronized with a corresponding second copy 25 on the local mass storage device 22b of the second server computer 12b. In relation to this, in particular steps 68 to 75 of FIG. 6B are used.

In a step 68, the first server computer 12a combines an update message with all changed content of the virtual mass storage device 13. For example, the content of all blocks or sectors of the first copy 24 of the virtual mass storage device 13 which are marked as changed in step 66 is combined with suitable address information in an update message.

In a subsequent step 69, the update message from the first server computer 12a is transferred via the data network 15 to the second server computer 12b and if necessary to further server computers 12 which also hold a local copy of the virtual mass storage device 13 of the virtual machine 11. To reduce network traffic, the transfer is preferably effected by a broadcast mechanism. Subsequently, the first server computer 12a optionally waits in step 70 to see whether the second server computer 12b and, if necessary, further server computers 12 have carried out and confirmed the synchronization as requested.

In parallel therewith, in a step 71 the second server computer 12b first receives the update message sent in step 69 and stores it on the local mass storage device 22b. With the aid of the information contained in the update message the second server computer 12b checks whether it holds a local copy 25 of the virtual mass storage device 13 of the virtual machine 11. If so, it takes over the changed blocks or sectors in a step 72 so that subsequently the second copy 25 of the virtual mass storage device 13 of the virtual machine 11 is located on the local mass storage device 22b of the second server computer 12b corresponding to the first copy 24 on the local mass storage device 22a of the first server computer 12a. If an error then arises such, as for example, an interruption in the power supply, the update can be repeated or continued at a later stage with the aid of the locally stored data.

In step 73, a check is optionally made whether problems occurred during the synchronization. For example, the update message could only be received in an incomplete manner or with errors. If so, then in a step 74 the renewed transfer of the update message is requested by the first server computer 12a. Otherwise, a confirmation message about the completed synchronization of the local mass storage device 22b is preferably produced. This confirmation message is received in a step 75 by the first server computer 12a, whereby the synchronization process is concluded and the method is again continued in step 61. If on the other hand, after a predetermined period, no confirmation message is received from the second server computer 12b, the first server computer 12a assumes that the synchronization was not carried out successfully and again issues an update message in step 69. Alternatively or additionally, implementation of the synchronization can also be coordinated by a central service of the memory server software.

Steps 68 to 75 are coordinated by the synchronization module 32 or the administration service 34 of the first server computer 12a. During updating, the state of the first copy 24 is frozen. For example, by a filter driver, further write accesses to the first copy 24 are interrupted or buffered locally until the synchronization is concluded.

The described cluster systems and working methods can be combined with and supplement one another in many ways to obtain different examples of my systems and methods in dependence upon the prevailing requirements.

In one example, all virtual mass storage devices 13 of each virtual machine 11 are held and synchronized with one another on all local mass storage devices 22 of each server computer 12 of a cluster system so that each virtual machine 11 can be executed on each server computer 12 and at the same time an additional data redundancy is created. In another example, virtual mass storage devices 13 from a sub-set of the virtual machines 11 are held on a sub-group of the server computers 12 so that the corresponding virtual machines 11 can be executed on each of the server computers 12 of the sub-group. This example is a compromise with respect to the size requirement of the local mass storage device 22 and the flexibility of execution of the individual virtual machines 11. In a further example, there are in each case precisely two copies of a virtual mass storage device 13 on two different server computers 12a and 12b, which means that the redundant operation of each virtual machine 11 is assured in the event of failure of any one server computer 12.

The described approach leads to a series of further advantages. For example, the server computer 12 on which the memory server software 33 is operated no longer has to be particularly secured against failure because its function can be taken over by each server computer 12 of the cluster system. By simultaneous distribution of data accesses to a plurality of mass storage devices, it is possible to dispense with the use of special hardware such as, in particular, high-performance network components and hard disks and RAID systems.

1-10. (canceled)

11. A method of executing a plurality of virtual machines on a plurality of server computers comprising:
starting a first virtual machine on a first server computer with a first local mass storage device;
starting a second virtual machine on a second server computer with a second local mass storage device;
receiving a first write request from the first virtual machine;
carrying out the first write request to change first data on the first local mass storage device;
receiving a second write request from the second virtual machine;
carrying out the second write request to change second data on the second local mass storage device;
synchronizing changed first data between the first server computer and the second server computer via a data network; and
synchronizing changed second data between the second server computer and the first server computer via the data network;
wherein, in synchronizing, the changed first or second data, changed data of more than one write request of the first virtual machines or the second virtual machines are combined for a specific period of time or for a specific volume of data and combined changes are transferred together to the second server computer or the server first computer, respectively.

12. The method according to claim 11, in which synchronizing the changed first and the changed second data include partial steps comprising:
transferring the changed first or second data from the first server computer to the second server computer or from the second server computer to the first server computer;
buffering transferred data on the local second or first mass storage device; and
writing the transferred data to the local second mass storage device or the local first mass storage device, after all transferred data has been buffered.

13. The method according to claim 11, in which synchronizing the changed first and the changed second data further comprises:
marking the changed first data or changed second data on the first mass storage device or the second mass storage device;
sending a confirmation of a writing of the changed data from the second server computer to the first server computer or from the first server computer to the second server computer; and
cancelling the marking of the changed data on the first local mass storage device or the second local mass storage device, after the confirmation has been received by the second server computer or the first server computer.

14. The method according to claim 11, further comprising:
pausing the first virtual machine on the first server computer;
waiting until the step of synchronizing the first changed data has been completed;
subsequently starting the first virtual machine on the second server computer;
receiving a third write request from the first virtual machine;
carrying out the third write request to change third data on the second local mass medium; and
synchronizing the changed third data between the second server computer and the first server computer via the data network.

15. The method according to claim 11, further comprising:
pausing the first virtual machine on the first server computer;
close in time thereto, starting the first virtual machine on the second server computer;
receiving a read request from the first virtual machine via the second server computer;
providing requested data via the second local mass medium when synchronizing the first changed data is completed; and
diverting the read request to the first server computer and providing the requested data via the first local mass storage device when synchronizing the first changed data has not yet been completed.

16. A cluster system comprising:
a plurality of server computers each with at least one processor, at least one local mass storage device and at least one network component; and
a data network, via which the network components of the plurality of server computers are coupled to exchange data;
wherein
the cluster system is arranged to execute a plurality of virtual machines;
each of the virtual machines is allocated at least one virtual mass storage device;
for each virtual machine, a first copy of the data of the allocated virtual mass storage device is stored on the at least one local mass storage device of a first server computer and a second copy of the data of the allocated virtual mass storage device is stored on the at least one local mass storage device of a second server computer of the plurality of server computers;
during execution of an active virtual machine of the plurality of virtual machines by the at least one processor of the first server computer mass storage device accesses of the active virtual machine to the at least one virtual mass storage device allocated thereto are redirected to the local mass storage device of the first server computer;
during execution of the active virtual machines by the at least one processor of the second server computer mass storage device accesses of the active virtual machine to the at least one virtual mass storage device allocated thereto are redirected to the local mass storage device of the second server computer; and
changes in the first copy and in the second copy of the data of the virtual mass storage device of the active virtual machine are synchronized via the data network with the second copy and the first copy, respectively.

17. The cluster system according to claim 16, in which each of the plurality of server computers has a synchronization module, wherein the synchronization module of the first server computer is arranged to combine changes in the first copy of the data of the virtual mass storage device of the active virtual machine for a specific period of time or for a specific volume of data and to transfer them together to the second server computer.

18. The cluster system according to claim 17, in which a copy of data of the virtual mass storage device of the active virtual machine is stored on the at least one local mass storage device of each server computer of the plurality of server computers and the changes in the first copy are distributed by the synchronization module of the local server computer by a common communication to all other server computers.

19. The cluster system according to claim 16, in which memory server software is executed by a virtual machine executed on the at least one server computer, wherein the memory server software is arranged to provide content of the virtual mass storage devices of the plurality of virtual machines via the data network.

20. The cluster system according to claim 19, in which each of the plurality of server computers has a filter driver, wherein the filter driver is arranged to intercept mass storage device accesses by a virtual machine locally executed by the at least one processor of the server computer and to redirect them to the first copy of the data of the at least one virtual mass storage device on the local mass storage device.

21. A method of executing a plurality of virtual machines on a plurality of server computers comprising:
starting a first virtual machine on a first server computer with a first local mass storage device;
starting a second virtual machine on a second server computer with a second local mass storage device;
receiving a first write request from the first virtual machine;
carrying out the first write request to change first data on the first local mass storage device;
receiving a second write request from the second virtual machine;
carrying out the second write request to change second data on the second local mass storage device;
synchronizing changed first data between the first server computer and the second server computer via a data network; and
synchronizing changed second data between the second server computer and the first server computer via the data network.

22. The method according to claim 21, wherein, in synchronizing the changed first or second data, changed data of more than one write request of the first virtual machines or the second virtual machines are combined for a specific period of time or for a specific volume of data and the combined changes are transferred together to the second server computer or the server first computer, respectively.

23. The method according to claim 21, in which synchronizing the changed first and the changed second data include partial steps comprising:
transferring the changed first or second data from the first server computer to the second server computer or from the second server computer to the first server computer;
buffering transferred data on the local second or first mass storage device; and
writing checked data to the local second mass storage device or the local first mass storage device, after all transferred data has been buffered.

24. The method according to claim 21, in which synchronizing the changed first and the changed second data include additional partial steps comprising:
marking the changed first data or changed second data on the first mass storage device or the second mass storage device;
sending a confirmation of a writing of the changed data from the second server computer to the first server computer or from the first server computer to the second server computer; and
cancelling the marking of the changed data on the first local mass storage device or the second local mass storage device, after the confirmation has been received by the second server computer or the first server computer.

25. The method according to claim 21, further comprising:
pausing the first virtual machine on the first server computer;
waiting until synchronizing the first changed data has been completed;
subsequently starting the first virtual machine on the second server computer;
receiving a third write request from the first virtual machine;
carrying out the third write request to change third data on the second local mass medium; and
synchronizing the changed third data between the second server computer and the first server computer via the data network.

26. The method according to claim 21, further comprising:
pausing the first virtual machine on the first server computer;
close in time thereto, starting the first virtual machine on the second server computer;
receiving a read request from the first virtual machine via the second server computer;
providing the requested data via the second local mass medium when synchronizing the first changed data is completed; and
diverting the read request to the first server computer and providing the requested data via the first local mass storage device when synchronizing the first changed data has not yet been completed.
